(19) United States
(12) Patent Application Publication
(10) Pub. No.: US 2003/0193931 A1
(43) Pub. Date: Oct. 16, 2003

(54) Data/audio multiplexer/demultiplexer, data/audio multiplex transmission system, and methods thereof

(76) Inventors: Tomohiro Otani, Kamifukuoka-shi (JP); Masatoshi Suzuki, Kamifukuoka-shi (JP)

Correspondence Address: CHRISTIE, PARKER & HALE, LLP, 350 WEST COLORADO BOULEVARD, SUITE 500, PASADENA, CA, 91105, US

(21) Appl. No.: 10/411,515

(22) Filed: Apr. 10, 2003

(30) Foreign Application Priority Data
Apr. 16, 2002 (JP) 2002-112809

(51) Int. Cl. H04L 12/66

(52) U.S. Cl. 370/352

(57) ABSTRACT

A data/audio multiplex transmission system comprising an audio modulator to modulate an input audio signal and output the modulated audio signal, an optical pulse signal generator to generate an optical pulse signal for carrying a LAN data, amplitude of the optical pulse signal being modulated by the modulated audio signal, according to the LAN data and the modulated audio signal, an optical fiber to propagate the optical signal output from the optical pulse signal generator, an opto-electric converter to convert the optical signal propagated on the optical fiber into an electric signal, a filter to extract a predetermined band out of the output signal from the opto-electric converter, an audio demodulator to demodulate the audio signal out of the output from the filter, and a data transmitter to transmit the LAN data included in the output signal from the opto-electric converter for a LAN.

### CROSS REFERENCE TO RELATED APPLICATIONS

This application claims priority to Japanese Patent Application No. 2002-112809, filed Apr. 16, 2002, the entire contents of which are incorporated herein by reference.

### FIELD OF THE INVENTION

This invention generally relates to a system, method, and apparatus for multiplex-transmitting a data and audio, and more specifically relates to a data/audio multiplexer/demultiplexer which gives an additional function for multiplexing/demultiplexing audio signal to an optical transceiver which transmits and receives a data through optical fibers, data/audio multiplex transmission system, and methods thereof.

### BACKGROUND OF THE INVENTION

Internet access through the medium of an optical fiber called FTTH (Fiber To The Home) has been utilized. In the FTTH, an apparatus to convert a format and protocol of a transmission data is disposed between an optical fiber and a LAN or computer. Such apparatus is generally called a media converter.

Also, well-known is a configuration in which a dedicated telephone is connected to a terminal adapter which interconverts between an audio signal and an IP data, the terminal adapter being connected to a LAN (Local Area Network) terminal (e.g. 10/100 BASE-T) of an ADSL (Asymmetric Digital Subscriber Line) modem or media converter.

A conventional media converter is used exclusively for data transmission and thus it is required to provide a separate telephone line to use the usual telephone service.

Needless to say, when an audio signal is transmitted as a digital data on an access line (an ADSL line or optical fiber of FTTH) for connecting to the Internet, a telephone line is unnecessary. However, to perform this operation, it is necessary to connect a microphone and speaker for telephonic communication with a computer and to install audio service control software to process a telephone signal. Another method is to provide a dedicated terminal adapter to intermediate between audio signals and IP data. Such terminal adapter is a sort of alternate of the audio service control software on computer.

### SUMMARY OF THE INVENTION

A data/audio multiplexer/demultiplexer according to the invention comprises a data receiver connectable with a LAN, an audio modulator to modulate an input first audio signal and to output the modulated audio signal, an optical pulse signal generator to generate an optical pulse signal for carrying first data signal from the LAN received by the data receiver, amplitude of the optical pulse signal being modulated by the modulated audio signal, according to the first data signal and the modulated audio signal, an opto-electric converter to convert an input optical signal carrying second audio signal and second data signal into an electric signal, a filter to extract a predetermined band out of the signal output from the opto-electric converter, an audio demodulator to demodulate the second audio signal out of the output from the filter, and a data transmitter connectable to the LAN to output the second data signal included in the output signal from the opto-electric converter for the LAN.

With the above configuration, telephonic communication is superimposed on a data communication line. That is, there is no need to provide a dedicated terminal adapter or another telephone line for telephonic communication.

Preferably, the optical pulse signal generator comprises an amplitude modulator to analog-modulate the pulse amplitude of the first data signal from the LAN received by the data receiver with the modulated audio signal and an electrooptic converter to convert the output signal from the amplitude modulator to an optical signal. With this configuration, telephonic communication is superimposed on a data communication line with low-cost means.

Preferably, the data/audio multiplexer/demultiplexer according to the invention further comprises a telephone connector to connect a telephone wherein the first audio signal enters the audio modulator through the telephone connector from the telephone and the second audio signal output from the audio demodulator is applied to the telephone through the telephone connector. With this configuration, an existing telephone is easily connected to the apparatus.

Preferably, the data transmitter comprises a waveform shaper to shape a pulse waveform of the output signal from the opto-electric converter. With this configuration, distortion of a pulse waveform due to the audio multiplex is improved.

A data/audio multiplexing/demultiplexing method according to the invention comprises an audio modulating step for modulating a first audio signal and outputting the modulated audio signal, an optical pulse signal generating step for generating an optical pulse signal for carrying first data signal input from a LAN, amplitude of the optical pulse signal being modulated by the modulated audio signal, according to the first data signal and the modulated audio signal, an opto-electric converting step for converting an input optical signal carrying second audio signal and second data signal into an electric signal, a band extracting step for extracting a predetermined band from the electric signal obtained in the opto-electric converting step, an audio demodulating step for demodulating the second audio signal from the signal having the band extracted in the band extracting step, and a data transmitting step for transmitting the second data signal included in the electric signal obtained in the opto-electric converting step for the LAN.

With the above configuration, telephonic communication is superimposed on a data communication line. That is, there is no need to provide a dedicated terminal adapter or another telephone line for telephonic communication.

Preferably, the optical pulse signal generating step comprises a pulse amplitude modulating step to analog-modulate pulse amplitude of the first data signal input from the LAN with the modulated audio signal obtained in the audio modulating step and an electrooptic converting step to convert the pulse signal whose amplitude was modulated in the pulse amplitude modulating step into an optical signal. With this configuration, telephonic communication is superimposed on a data communication line with low-cost means.

Preferably, the data transmitting step comprises a waveform shaping step to shape a pulse waveform of the second data signal included in the electric signal obtained in the opto-electric converting step. With this configuration, distortion of a pulse waveform due to the audio multiplex is improved.

A data/audio multiplex transmission system according to the invention comprises an audio modulator to modulate an input audio signal and to output the modulated audio signal, an optical pulse signal generator to generate an optical pulse signal for carrying a LAN data, amplitude of the optical pulse signal being modulated by the modulated audio signal, according to the LAN data and modulated audio signal, an optical fiber to transmit the optical signal output from the optical pulse signal generator, an opto-electric converter to convert the optical signal propagated on the optical fiber into an electric signal, a filter to extract a predetermined band from the output signal from the opto-electric converter, an audio demodulator to demodulate the audio signal from the output from the filter, and a data transmitter to transmit the LAN data included in the output signal from the opto-electric converter for the LAN.

Preferably, the optical pulse signal generator comprises an amplitude modulator to analog-modulate pulse amplitude of the LAN data signal with the modulated audio signal and an electrooptic converter to convert the output signal from the amplitude modulator into an optical signal. With this configuration, telephonic communication is superimposed on a data communication line with low-cost means.

Preferably, the data transmitter comprises a waveform shaper to shape a pulse waveform of the output signal from the opto-electric converter. With this configuration, distortion of a pulse waveform due to the audio multiplex is improved.

A data/audio multiplex transmission method according to the invention comprises an audio modulating step to modulate an input audio signal and to output the modulated signal, an optical pulse signal generating step to generate an optical pulse signal for carrying a LAN data, amplitude of the optical pulse signal being modulated by the modulated audio signal, according to the LAN data and modulated audio signal and to output the generated optical pulse signal onto an optical transmission medium, an opto-electric converting step to convert the optical signal propagated on the optical transmission medium into an electric signal, a band extracting step to extract a predetermined band from the electric signal obtained in the opto-electric converting step, an audio demodulating step to demodulate the modulated audio signal from the signal having the band extracted in the band extracting step, and a data transmitting step to transmit the LAN data included in the electric signal obtained in the opto-electric converting step for the LAN.

Preferably, the optical pulse signal generating step comprises a pulse amplitude modulating step to analog-modulate pulse amplitude of the LAN data with the modulated audio signal and an electrooptic converting step to convert the pulse signal whose amplitude is modulated in the pulse amplitude modulating step into an optical signal and to output the optical signal on to the optical transmission medium. With this configuration, telephonic communication is superimposed on a data communication line with low-cost means.

Preferably, the data transmitting step comprises a waveform shaping step to shape a pulse waveform of the LAN data included in the electric signal obtained in the opto-electric converting step. With this configuration, distortion of a pulse waveform due to the audio multiplex is improved.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 shows a schematic block diagram of an explanatory embodiment according to the invention; and

FIG. 2 shows an example of output waveform from an AM modulator 40.

### DETAILED DESCRIPTION

Explanatory embodiments of the invention are explained below in detail with reference to the drawings.

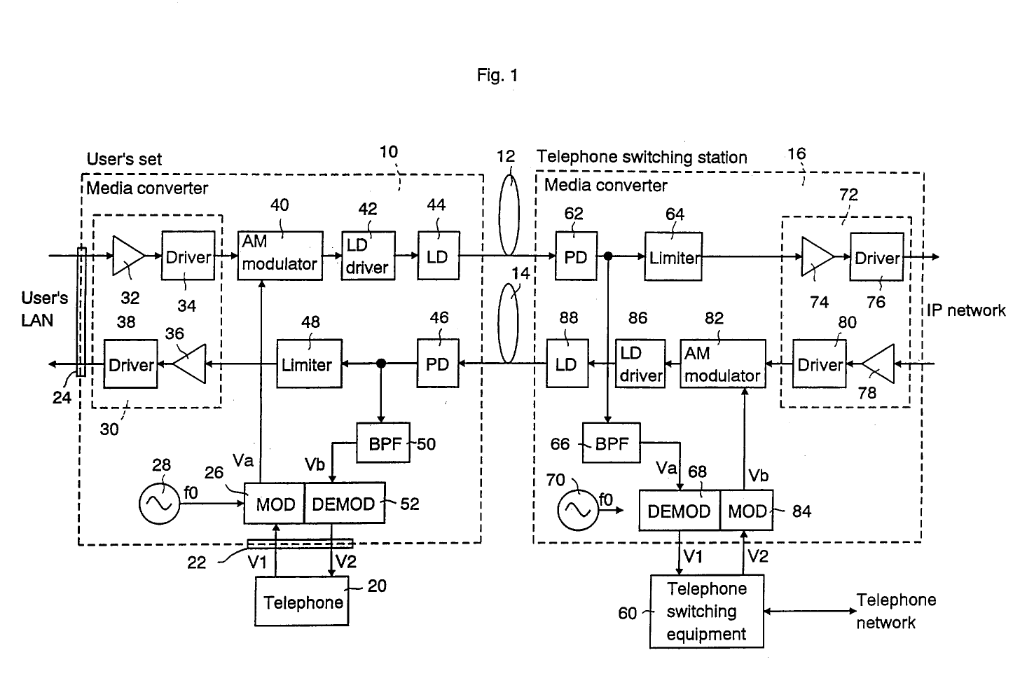

FIG. 1 shows a schematic block diagram of an explanatory embodiment according to the invention. A media converter 10 installed in a user's set connects to a media converter 16 at a telephone switching station through optical fibers 12 and 14. The optical fiber 12 transmits a signal from the media converter 10 to the media converter 16, and the optical fiber 14 transmits a signal from the media converter 16 to the media converter 10.

First, the transmission of a data D1 and audio signal V1 from the user's house to the telephone switching station is explained below.

The media converter 10 comprises a telephone modular jack 22 to connect with a telephone 20 to be used for a fixed telephone network and a 10/100 BASE-T terminal 24 to connect with a LAN. Although it is not illustrated in the drawing, a user's personal computer connects to the 10/100 BASE-T terminal 24 directly or through a LAN.

A modulator 26 modulates an audio signal V1 from the telephone 20 using a sine-wave signal of frequency f0 from a local oscillator 28. Any modulation mode of AM, FM, and PM is applicable. In this embodiment, since an audio signal is multiplexed through analog intensity modulation on an optical pulse signal of 100 Mbit/s or 10 Mbit/s on the optical fibers 12 and 14, it is preferable to shift components in a low frequency area including the direct current of an audio signal toward a higher frequency area. The bandwidth of a telephone signal is 4 kHz and so the oscillation frequency f0 of the local oscillator 28 should be 4 kHz or more, preferably 8˜10 kHz.

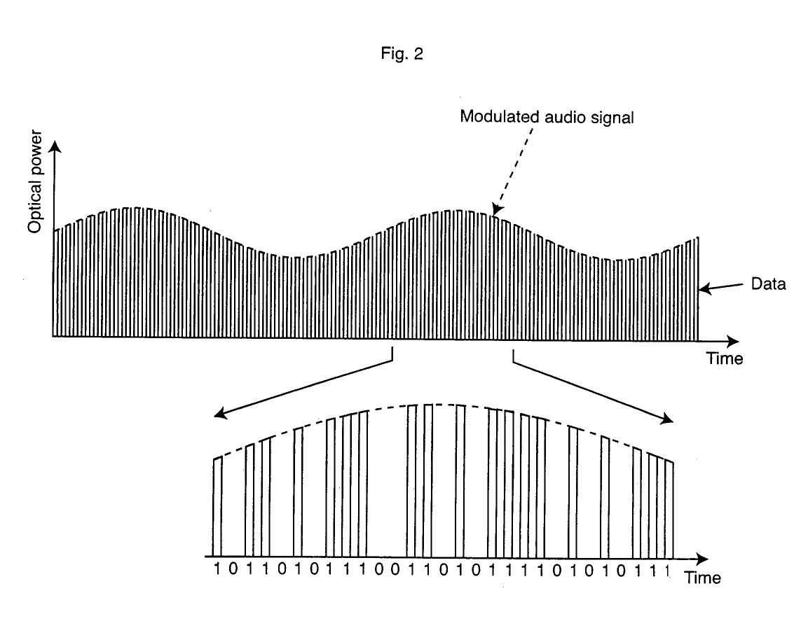

A buffer amplifier 32 in an Ethernet (Trademark) transceiver 30 amplifies a signal carrying a data D1 from a user's computer, and a driver 34 applies an output signal from the amplifier 32 to an AM modulator 40 with a predetermined voltage or current. The driver 34 is sometimes omitted or integrated with the buffer amplifier 32. An output Va from the modulator 26 is also applied to the AM modulator 40 as a modulating signal. The AM modulator 40 modulates amplitude of the data signal output from the driver 34 with the modulated audio signal Va from the modulator 26. FIG. 2 shows an example of output waveform from the AM modulator 40. In FIG. 2, although RZ transmission is illustrated as an example of a data transmission system to make it easily understandable, an NRZ transmission system or the other pulse signal transmission systems are also applicable. Furthermore, it is also possible to utilize a different pulse signal transmission system for each of the electric stage and optical stage.

The AM modulator 40 comprises for example a variable gain amplifier to amplify the output signal from the driver 34 with a gain that varies according to the output level from the modulator 26. In other words, the AM modulator 40 multiplexes the modulated audio signal Va from the modulator 26 with the data signal to be transmitted for the telephone switching station.

An LD driver 42 drives a laser diode (LD) 44 according to the output from the AM modulator 40. The LD 44 generates an optical pulse signal for carrying the data D1 and whose amplitude is modulated by the modulated audio signal Va and outputs the generated optical pulse signal onto the optical fiber 12. Ideally, the output waveform from the LD 44 becomes equivalent to the waveform example shown in FIG. 2. That is, the output signal from the AM modulator 40 is converted to an optical signal by the LD driver 42 and LD 44. It is also applicable that the LD driver 42 comprises such a function to convert from NRZ to RZ or from NRZ to RZ.

As described above, the multiplexed data D1 and audio signal V1 propagates on the optical fiber 12 and enters the media converter 16 on the telephone switching station side.

In the media converter 16 at the telephone switching station, a photodiode 62 converts the optical signal from the optical fiber 12 into an electric signal. The output from the photodiode 62 is applied to a limiter 64 and to a bandpass filter (BPF) 66 which extracts the modulated audio signal Va. The limiter 64 is disposed to flatten the pulse amplitude fluctuated by the modulated audio signal Va. If such consideration is unnecessary, the limiter 64 can be omitted. It is also applicable to dispose a waveform shaper to shape the pulse signal waveform instead of the limiter 64.

The output from the limiter 64 enters a buffer amplifier 74 of an Ethernet transceiver 72. The buffer amplifier 74 amplifies the output signal from the limiter 64, and a driver 76 outputs the output signal from the amplifier 74 according to a predetermined voltage or current onto the IP network. The driver 76 is sometimes omitted or integrated with the buffer amplifier 74. An IP data signal carrying the data D1 is output from the driver 76 for the IP network.

The BPF 66 extracts the modulated audio signal Va out of the output from the photodiode 62. A demodulator 68 demodulates the output from the BPF 66 using a sine wave output signal of frequency f0 from a local oscillator 70 to restore the audio signal V1. The restored audio signal V1 is applied to a telephone switching equipment 60. The telephone switching equipment 60 outputs the received audio signal V1 for a telephone network.

As described above, the data D1 and audio signal V1 are transmitted from the user's set to the telephone switching station.

Next, the transmission of a data D2 and audio signal V2 from the telephone switching station to the user's set is explained below. This operation is practically identical to the transmission of the data D1 and audio signal V1 from the user's set to the telephone switching station.

The telephone switching equipment 60 applies a telephone audio signal V2 input from the telephone network to a modulator 84 in the media converter 16 at the telephone switching station. The modulator 84 modulates the audio signal V2 from the telephone switching equipment 60 with the sine wave signal of frequency f0 from the local oscillator 70. The modulation mode can be any one of AM, FM and PM.

A buffer amplifier 78 in the Ethernet transceiver 72 amplifies a signal from the IP network for carrying the data D2, and a driver 80 applies the output signal from the amplifier 78 according to a predetermined voltage or current to an AM modulator 82. The driver 80 is sometimes omitted or integrated with the buffer amplifier 78. An output Vb from the modulator 84 is also applied to the AM modulator 82 as a modulating signal. The AM modulator 82 modulates amplitude of the data signal output from the driver 80 with the modulated audio signal Vb from the modulator 84. In other words, the AM modulator 82 multiplexes the modulated audio signal Vb from the modulator 84 with the data signal to be transmitted for the user's set.

An LD driver 86 drives a laser diode (LD) 88 according to the output from the AM modulator 82. The LD 88 generates an optical pulse signal for carrying the data D2 and whose amplitude is modulated by the modulated audio signal Vb and outputs the generated optical pulse signal onto the optical fiber 14. That is, the output signal from the AM modulator 82 is converted into an optical signal by the LD driver 86 and LD 88.

As described above, the multiplexed data D2 and audio signal V2 propagates on the optical fiber 14 and enters the media converter 10 in the user's set.

In the media converter 10 in the user's set, the photodiode 46 converts the optical signal from the optical fiber 14 into an electric signal. The output from the photodiode 46 is applied to the limiter 48 and to the bandpass filter (BPF) 50 which extracts the modulated audio signal Vb. The limiter 48 is disposed to flatten the pulse amplitude fluctuated by the modulated audio signal Vb. If such consideration is unnecessary, the limiter 48 can be omitted. It is also applicable to dispose a waveform shaper to shape a pulse signal waveform instead of the limiter 48.

The output from the limiter 48 enters a buffer amplifier 36 in the Ethernet transceiver 30. The buffer amplifier 36 amplifies the output signal from the limiter 48, and a driver 38 outputs the output signal from the amplifier 36 according to a predetermined voltage or current for a LAN in the user's set. The driver 38 is sometimes omitted or integrated with the buffer amplifier 36. An IP data signal for carrying the data D2 is output from the driver 38 for the user's LAN.

The BPF 50 extracts the modulated audio signal Vb out of the output from the photodiode 46. A demodulator 52 demodulates the output from the BPF 50 with the sine wave output signal of frequency f0 from the local oscillator 70 to restore the audio signal V2. The restored audio signal V2 is applied to the telephone 20 through the modular jack 22.

As described above, the data D2 and audio signal V2 are transmitted from the telephone switching station to the user's set.

As already mentioned, the drivers 34, 38, 76, 80 in the transceivers 30 and 72 can be omitted. Also, the limiters 48 and 64 can be omitted. Obviously, it is possible to use LPFs instead of the BPFs 50 and 66.

Although an embodiment applied for FTTH is explained here, the invention is applicable to the other access systems such as an access line of Ether-VPN.

In the embodiment shown in FIG. 1, although the two optical fibers 12 and 14 are connected between the media converters 10 and 16 to make it easy to understand, it is also applicable to use a single optical fiber bidirectionally. For instance, by assigning a different wavelength to each of the up and down flows, an up signal light and a down signal light can be easily separated.

Furthermore, it is obvious that data terminals such as a computer can be directly connected to the media converters 10 and 16. That is, the LAN claimed in the present invention includes the data terminals as well.

In the above embodiment, although the audio signal and data signal are multiplexed in the electric state, it is also applicable to convert the data into an optical state first and then modulate the pulse amplitude of the optical pulse signal with a modulated audio signal.

As readily understandable from the aforementioned explanation, according to the invention, data communication represented by the Internet and existing telephone are efficiently united. Furthermore, it is possible to continue the telephone service without canceling the previous telephone service and without paying doubly for the telephone service. Since the invention is realized by merely adding a few low-cost parts to a media converter, the production cost can be kept very low.

While the invention has been described with reference to the specific embodiment, it will be apparent to those skilled in the art that various changes and modifications can be made to the specific embodiment without departing from the spirit and scope of the invention as defined in the claims.

1. A data/audio multiplexer/demultiplexer comprising:
a data receiver connectable with a LAN;
an audio modulator to modulate an input first audio signal and output the modulated audio signal;
an optical pulse signal generator to generate an optical pulse signal for carrying first data signal from the LAN received by the data, amplitude of the optical pulse signal being modulated by the modulated audio signal, according to the first data signal and the modulated audio signal;
an opto-electric converter to convert an input optical signal carrying second audio signal and second data signal into an electric signal;
a filter to extract a predetermined band out of the output signal from the opto-electric converter;
an audio demodulator to demodulate the second audio signal from the output from the filter; and
a data transmitter connectable with the LAN to output the second data signal included in the output signal from the opto-electric converter for the LAN.

2. The apparatus of claim 1 wherein the optical pulse signal generator comprises
a amplitude modulator to analog-modulate pulse amplitude of the first data signal from the LAN received by the data receiver with the modulated audio signal; and
an electrooptic converter to convert the output signal from the amplitude modulator into an optical signal.

3. The apparatus of claim 1 further comprising a telephone connector to connect with a telephone, wherein the first audio signal enters the audio modulator through the telephone connector from the telephone and the second audio signal output from the audio demodulator is applied to the telephone through the telephone connector.

4. The apparatus of claim 1 wherein the data transmitter comprises a waveform shaper to shape a pulse waveform of the output signal from the opto-electric converter.

5. A method for multiplexing/demultiplexing data and audio signal comprising steps of:
modulating first audio signal and outputting the modulated audio signal;
generating an optical pulse signal to carry a first data signal input from a LAN, amplitude of the optical pulse signal being modulated by the modulated audio signal, according to the first data signal and the modulated audio signal;
converting an input optical signal carrying second audio signal and second data signal into an electric signal;
extracting a predetermined band out of the electric signal obtained at the opto-electric converting step;
demodulating the second audio signal out of the band extracted at the band extracting step; and
transmitting the second data signal included in the electric signal obtained at the opto-electric converting step for the LAN.

6. The method of claim 5 wherein the optical pulse signal generating step comprises steps of
analog-modulating pulse amplitude of the first data signal input from the LAN with the modulated audio signal obtained at the audio modulating step; and
converting the pulse signal whose amplitude is modulated at the pulse amplitude modulating step into an optical signal.

7. The method of claim 5 wherein the data transmitting step comprises a step of shaping a pulse waveform of the second data signal included in the electric signal obtained at the opto-electric converting step.

8. A data/audio multiplex transmission system comprising:
an audio modulator to modulate an input audio signal and output the modulated audio signal;
an optical pulse signal generator to generate an optical pulse signal for carrying a LAN data, amplitude of the optical pulse signal being modulated by the modulated audio signal, according to the LAN data and the modulated audio signal;
an optical fiber to propagate the optical signal output from the optical pulse signal generator;
an opto-electric converter to convert the optical signal propagated on the optical fiber into an electric signal;
a filter to extract a predetermined band out of the output signal from the opto-electric converter;
an audio demodulator to demodulate the audio signal out of the output from the filter; and
a data transmitter to transmit the LAN data included in the output signal from the opto-electric converter for a LAN.

9. The system of claim 8 wherein the optical pulse signal generator comprises
an amplitude modulator to analog-modulate pulse amplitude of the LAN data signal with the modulated audio signal; and
an electrooptic converter to convert the output signal from the amplitude modulator into an optical signal.

10. The system of claim 8 wherein the data transmitter comprises a waveform shaper to shape a pulse waveform of the output signal from the opto-electric converter.

11. A data/audio multiplex transmission method comprising steps of:
modulating an input audio signal and outputting the modulated audio signal;
generating an optical pulse signal to carry a LAN data, amplitude of the optical pulse signal being modulated by the modulated audio signal, according to the LAN data and the modulated audio signal and outputting the generated optical pulse signal onto an optical transmission medium;
converting the optical signal propagated on the optical transmission medium into an electric signal;
extracting a signal having a predetermined band out of the electric signal obtained at the opto-electric converting step;
demodulating the modulated audio signal out of the signal having the band extracted at the band extracting step; and
transmitting the LAN data included in the electric signal obtained at the opto-electric converting step for a LAN.

12. The method of claim 11 wherein the optical pulse signal generating step comprises steps of
analog-modulating pulse amplitude of the LAN data with the modulated audio signal; and
converting the pulse signal whose amplitude is modulated at the pulse amplitude converting step into an optical signal and outputting the optical signal onto the optical transmission medium.

13. The method of claim 11 wherein the data transmitting step comprises a step of shaping a pulse waveform of the LAN data included in the electric signal obtained at the opto-electric converting step.
